(19) United States
(12) Patent Application Publication
(10) Pub. No.: US 2021/0202190 A1
(43) Pub. Date: Jul. 1, 2021

(54) METAL CONTACT MEMBER AND RUBBER SWITCH MEMBER

(71) Applicant: SEKISUI POLYMATECH CO., LTD., Saitama (JP)

(72) Inventors: Manabu FUJITA, Saitama-shi, Saitama (JP); Takashi NAKAGAWA, Kita-ku, Tokyo (JP); Ryousuke SASAKI, Saitama-shi, Saitama (JP); Yohei YAMAMOTO, Saitama-shi, Saitama (JP)

(73) Assignee: SEKISUI POLYMATECH CO., LTD., Saitama (JP)

(21) Appl. No.: 17/057,740

(22) PCT Filed: May 28, 2019
(86) PCT No.: PCT/JP2019/021135

§ 371 Date: Nov. 23, 2020

(30) Foreign Application Priority Data
May 29, 2018 (JP) 2018-102101

(51) Int. Cl. H01H 13/12

(52) U.S. Cl. CPC H01H 13/12; H01H 2201/024; H01H 2201/026; H01H 2201/016

(57) ABSTRACT

A metal contact member 10 includes a metal sheet 15, which has a plurality of streaky projecting portions extend along each other on a front surface 15A of the metal sheet 15. A rubber switch member 12 includes the metal contact member 10 and a rubber switch body 11 joined to the metal contact member 10.

### TECHNICAL FIELD

The present invention relates to a metal contact member used for a switch contact and a rubber switch member equipped with the metal contact member.

### BACKGROUND ART

Various switches such as push button switches are widely used for electronic equipment such as home use devices, onboard devices, and cell phones. Regarding switch members making up push button switches and the like, those in which a contact member is joined to a switch body are known widely, where the contact member serves as a contact part for contact with a fixed contact point and the switch body is made of elastic material. The contact members used are those produced, for example, by gold-plating surfaces of metal sheets such as nickel silver sheets. Also, a rubber layer is often provided on a reverse side of the metal sheet making up the contact member to improve adhesiveness and the like to a switch body. As rubber making up the switch body and rubber layer, silicone rubber is used widely.

In general, a surface of the metal contact point is often smooth, but depressions and projections may be formed sometimes. For example, PTL1 discloses that a metal contact point includes a connection diaphragm joined to a switch body, and a contact part installed protruding from the connection diaphragm, and that separate depressed portions or a continuous depressed portion are/is formed in the contact part to receive minute foreign matter. According to PTL1, since the depressed portion(s) is/are provided, any foreign matter, such as dust, existing between the contact part and fixed contact point enters the depressed portion(s), ensuring contact area between the contact part and fixed contact point, and consequently poor conductivity is less prone to occur.

Also, as disclosed, for example, in PTL2, it is known that a switch whose switch body is made of a rubber elastic body is produced by so-called insert molding that molds a switch in one piece by placing a laminated body made up of a metal sheet and a rubber layer in a mold and charging rubber such as silicone rubber making up the switch body into the mold.

### CITATION LIST

### Patent Literature

PTL1: JP 2004-134241 A
PTL2: JP 63-096822 A

### SUMMARY OF INVENTION

### Technical Problem

However, if a switch is produced by integrally molding a metal sheet and rubber, as disclosed in PTL2, even if there is no foreign matter such as dust on a surface of the metal sheet making up the contact member, a surface resistance value of the metal sheet may increase, resulting in reduced electrical conductivity. The reduction in the electrical conductivity is relatively large when silicone rubber is used.

The present invention has been made in view of the above problem and has an object to curb an increase in surface resistance value of a metal sheet making up a metal contact member even when a switch member is produced by molding the metal sheet integrally with rubber such as silicone rubber.

### Solution to Problem

The present inventors have examined the cause of an increase in surface resistance value of a metal sheet in a switch member integrated with rubber, and have found out that a component derived from the rubber exists on a surface of the metal sheet, increasing the surface resistance value on the surface of the metal sheet. Then, after further conducting active studies, the present inventors have found out that by forming depressions and projections of a particular shape on the surface of the metal sheet, it is possible to curb an increase in the surface resistance value caused by the rubber-derived component, and completed the present invention described below.

[1] A metal contact member comprising a metal sheet, the metal sheet having a plurality of streaky projecting portions extending along each other on a surface of the metal sheet.
[2] The metal contact member according to [1] above, wherein the streaky projecting portions are formed intermittently.
[3] The metal contact member according to [1] or [2] above, wherein the surface of the metal sheet is 0.1 to 0.5 μm in arithmetic mean height (Sa), 960 to 20000 (l/mm) in arithmetic mean peak curvature (Spc), and 0.02 to 3.0 in developed interfacial area ratio (Sdr).
[4] The metal contact member according to any one of [1] to [3] above, further comprising a rubber layer laminated to a rear surface of the metal sheet.
[5] The metal contact member according to [4] above, wherein the rubber layer contains silicone rubber.
[6] A rubber switch member comprising the metal contact member according to any one of [1] to [5] above; and a rubber switch body joined to the metal contact member.
[7] The rubber switch member according to [6] above, wherein the rubber switch body contains silicone rubber.

### Advantageous Effects of Invention

The present invention can curb an increase in surface resistance value of the metal sheet making up the metal contact member.

### BRIEF DESCRIPTION OF DRAWINGS

FIG. 1 is a sectional view showing an overall configuration of a rubber switch member according to an embodiment of the present invention.

FIG. 2 shows an enlarged image obtained by observing a front surface of a metal sheet according to a first embodiment (Embodiment 1) under a laser microscope.

FIG. 3 shows an enlarged image obtained by observing a front surface of a metal sheet according to a second embodiment (Embodiment 2) under a laser microscope.

FIG. 4 shows an enlarged image obtained by observing a front surface of a metal sheet according to a third embodiment (Embodiment 3) under a laser microscope.

FIG. 5 is a diagram obtained by tracing the image shown in FIG. 2 by likening color gradation to contour lines.

FIG. 6 is a diagram obtained by tracing the image shown in FIG. 3 by likening color gradation to contour lines.

FIG. 7 is a diagram obtained by tracing the image shown in FIG. 4 by likening color gradation to contour lines.

### DESCRIPTION OF EMBODIMENTS

The present invention will be described in more detail below with reference to embodiments.

### (Rubber Switch Member)

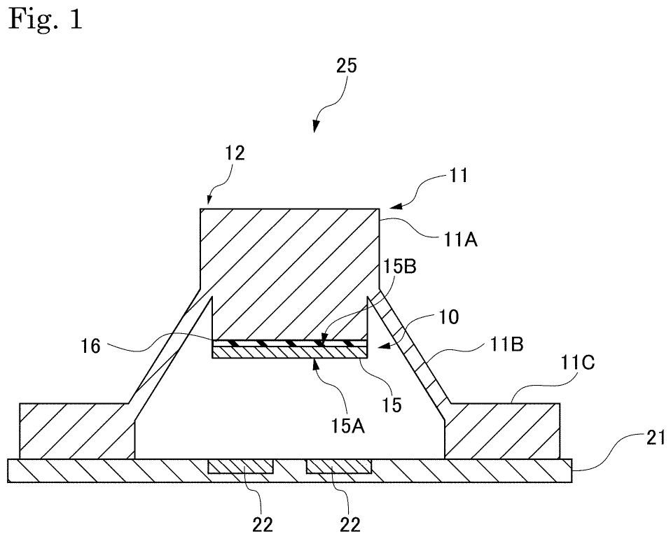

FIG. 1 is a sectional view showing an overall configuration of a switch including a rubber switch member according to an embodiment of the present invention. A switch 25 includes a rubber switch member 12 to which a metal contact member 10 is attached, and fixed contact points 22 installed on a substrate 21, where the metal contact member 10 is placed facing the fixed contact points 22.

The rubber switch member 12 includes a rubber switch body 11. The rubber switch body 11 includes a pusher 11A, a flexible portion 11B shaped like a skirt and configured to extend by spreading from the pusher 11A, and a base 11C connected to a tip of the flexible portion 11B. When the base 11C is mounted on an installation surface such as the substrate 21, the rubber switch body 11 is supported by the base 11C via the flexible portion 11B such that the pusher 11A will be installed by being spaced away from the substrate 21 (installation surface). The metal contact member 10 is joined to that surface of the pusher 11A which faces the substrate 21, thereby causing the metal contact member 10 to face the fixed contact points 22.

The pusher 11A is elastically supported by the base 11C via the flexible portion 11B formed into a thin-walled part and is able to get displaced with respect to the fixed contact points 22. When pushed from above, the pusher 11A sinks down approaching the substrate 21 and brings the metal contact member 10 into contact with the fixed contact points 22, thereby turning on the switch. On the other hand, when released from the pushed state, the pusher 11A floats up, causing the metal contact member 10 to separate from the fixed contact points 22 and thereby turning off the switch.

The metal contact member 10 includes a metal sheet 15. The metal sheet 15 is formed of metal such as copper, aluminum, or iron, or an alloy containing any of these metals. Regarding the alloy, nickel silver, which is a copper alloy, is preferable. The use of nickel silver improves electrical conductivity and corrosion resistance of the metal sheet 15. By bringing a front surface 15A of the metal sheet 15 into contact with the fixed contact points 22, the metal contact member 10 brings the fixed contact points 22 into conduction. A large number of streaky projecting portions extending along each other are formed on the front surface 15A as described later. The large number of streaky projecting portions are formed, for example, by forming a large number of groove-like depressed portions in parallel to one another. The thickness of the metal sheet 15 is, for example, 10 to 300 μm, and preferably 20 to 200 μm.

The metal contact member 10 may have any shape such as circular, oval, triangular, quadrangular, or pentagonal, but a circular shape is preferable.

Preferably a plating process is performed on the front surface 15A of the metal sheet 15, thereby forming a plating layer thereon. Possible metals making up the plating layer include nickel, chrome, tin, copper, gold, silver, zinc, and alloys containing any of these metals. Possible types of plating layer include a base plating layer formed directly on the surface of the metal sheet, a roughening plating layer intended to roughen the metal surface, and a protective plating layer intended to protect the metal surface. Generally, it is advisable that the roughening plating layer, protective plating layer, and the like are formed on the base plating layer.

Preferably a nickel plating layer is formed as the base plating layer on the front surface 15A of the metal sheet 15. The nickel plating layer is formed of nickel or an alloy containing nickel. This increases adhesion to the protective plating layer formed further on the surface and improves durability of the metal contact member 10.

Preferably a gold plating layer is formed as the protective plating layer on a surface of the base plating layer. The gold plating layer is formed of gold or an alloy containing gold. The formation of the gold plating layer on the front surface 15A improves electrical conductivity and durability of the metal contact member 10. The protective plating layer such as a gold plating layer is normally formed as the outermost layer of the front surface 15A.

The roughening plating layer which is formed on the base plating layer or which is the base plating layer itself that is formed into a roughened surface, as described later, makes the streaky projecting portions intermittent. When the roughening plating layer is formed, preferably a gold plating layer is formed further as a protective plating layer, and in that case, it is advisable that the roughening plating layer is used as a base layer and the gold plating layer is formed on the base layer. The roughening plating layer is formed of any of the metals described above or an alloy containing any of the metals, and preferably the roughening plating layer is formed of nickel.

The metal contact member 10 further includes a rubber layer 16. The rubber layer 16 is laminated to a rear surface 15B of the metal sheet 15. The metal sheet 15, which is joined to the rubber switch body 11 via the rubber layer 16, is bonded to the rubber switch body 11 with high adhesive strength. The thickness of the rubber layer 16 is, for example, 5 to 3000 μm, and preferably 10 to 1000 μm.

Examples of the rubber making up the rubber layer 16 include silicone rubber, urethane rubber, fluororubber, nitrile rubber, ethylene-propylene rubber, and thermoplastic elastomer, of which silicone rubber is preferable.

When silicone rubber is used, the rubber making up the rubber layer 16 may be simple silicone rubber, but other rubber components may be included as long as silicone rubber is contained. Also, the rubber layer 16 may be laminated to the rear surface 15B of the metal sheet 15 either directly or via a primer or the like.

The rubber switch body 11 is formed of rubber by integrating a pusher 12, a base 13, and a flexible portion 14. Examples of the rubber making up the rubber switch body 11 include silicone rubber, urethane rubber, fluororubber, nitrile rubber, ethylene-propylene rubber, and thermoplastic elastomer, of which silicone rubber is preferable from the viewpoint of high durability and low compression set.

The silicone rubber is liable to cause an increase in surface resistance value attributable to rubber-derived components as described later, but the present embodiment curbs an increase in the surface resistance value thanks to depressed portions described later, making poor conductivity less liable to occur. When silicone rubber is used, the rubber making up the rubber switch body 11 may be simple silicone rubber, but other rubber components may be included as long as silicone rubber is contained.

Note that the rubber of the rubber switch body and rubber layer may be made up of the rubber components described above, but generally contains various additives in addition to the rubber components.

### (Surface Geometry of Metal Sheet)

Next, a geometry of a front surface 15A of the metal sheet according to the present invention will be described with reference to embodiments. Whereas description will be given below using first to third embodiments, the present invention is not limited to these embodiments.

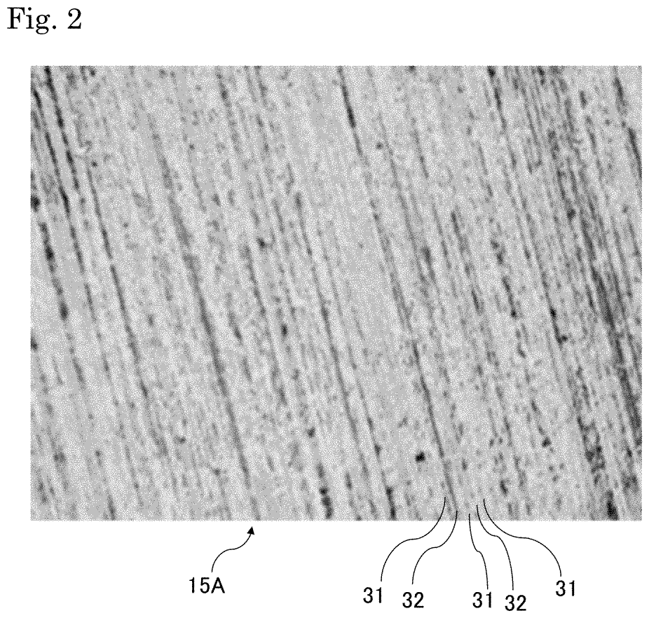

FIG. 2 is an enlarged image showing the front surface 15A of the metal sheet 15 according to the first embodiment. As shown in FIG. 2, a large number of groove-like depressed portions 31 extending along each other are formed on the front surface 15A of the metal sheet 15. A streaky projecting portion 32 is formed between each pair of depressed portions 31, thereby making the front surface 15A an uneven surface. Each of the groove-like depressed portions 31 and streaky projecting portions 32 is formed into an elongated line. The plural streaky projecting portions 32 may be parallel to one another, but do not have to be strictly parallel as long as the projecting portions 32 extend in a substantially same direction. On the front surface 15A, the projecting portion 32 between each pair of depressed portions 31 serves as a contact part configured to come into contact with the fixed contact points 22.

The rubber making up the rubber switch body 11 and the like of a rubber switch 20 may have part of components separated due to heating during molding when the metal contact member 10 and rubber switch body 11 are molded integrally. In particular, in the case of silicone rubber, organosilicon compounds such as organosiloxane compounds and silicon atom-containing compounds such as silica compounds are prone to separate from the rubber switch body 11. The separated rubber-derived components, if deposited on the front surface 15A of the metal sheet 15, increase the surface resistance value of the metal sheet 15, but according to the present embodiment, since large numbers of groove-like depressed portions 31 and streaky projecting portions 32 are formed on the front surface 15A, such increase in the surface resistance value are curbed and decreases in electrical conductivity are prevented.

The principle whereby an increase in the surface resistance value is curbed is not clear, but it is presumed that the rubber-derived components, such as organosilicon compounds and silica compounds, separated during molding and the like enter the groove-like depressed portions 31, decreasing the amounts of the rubber-derived components depositing on the projecting portions (contact part) 32. Also, it is presumed that since the depressed portions 31 are groove-shaped, certain convection occurs on the front surface 15A of the metal sheet 15, causing the rubber-derived components to flow in the depressed portions 31 in a gaseous state or in a state of liquid droplets and thereby become less liable to stay on the front surface 15A.

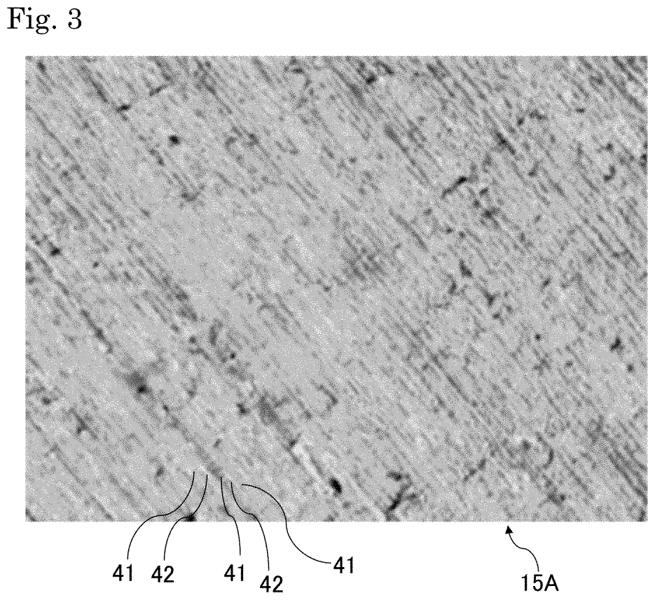

FIG. 3 is an enlarged image obtained by observing a front surface 15A of a metal sheet 15 according to a second embodiment of the present invention. In the second embodiment, again a large number of groove-like depressed portions 41 extending along each other are formed on the front surface 15A of the metal sheet 15. A streaky projecting portion 42 is formed between each pair of depressed portions 41, thereby making the front surface 15A an uneven surface.

According to the present embodiment, the streaky projecting portions 42 are formed intermittently. That is, the streaky projecting portions 42 are formed by dividing elongated linear projecting portions into segments. Each of the projecting portions 42 resulting from the division does not need to be linear, and it is sufficient if the segments, when linked together, form a linear shape. On the front surface 15A, the projecting portions 42 serve as a contact part configured to come into contact with the fixed contact points 22. The projecting portions 42 are formed in such a manner that the projecting portion 42 between the depressed portions 41, which have been formed into continuous linear grooves, is divided by etching and the like described later.

On the front surface of the metal sheet according to the second embodiment, as with the first embodiment, it is presumed that rubber-derived components enter the depressed portions 41, reducing rubber-derived components staying on the projecting portions (contact part) 42. Also, it is presumed that since the projecting portions 42 are intermittent, making adjacent groove-like depressed portions 41 partially connected, certain convection occurs on the front surface 15A of the metal sheet 15, making the rubber-derived components in a liquid state or in a state of liquid droplets less liable to stay on the front surface 15A and thereby preventing an increase in the surface resistance value.

Also, it is presumed that since the adjacent groove-like depressed portions 41 are partially connected, convection occurs in vertical and lateral directions on the front surface 15A of the metal sheet 15, making the rubber-derived components still less liable to stay on the projecting portions 42 on the front surface 15A and thereby making the surface resistance value still less liable to increase.

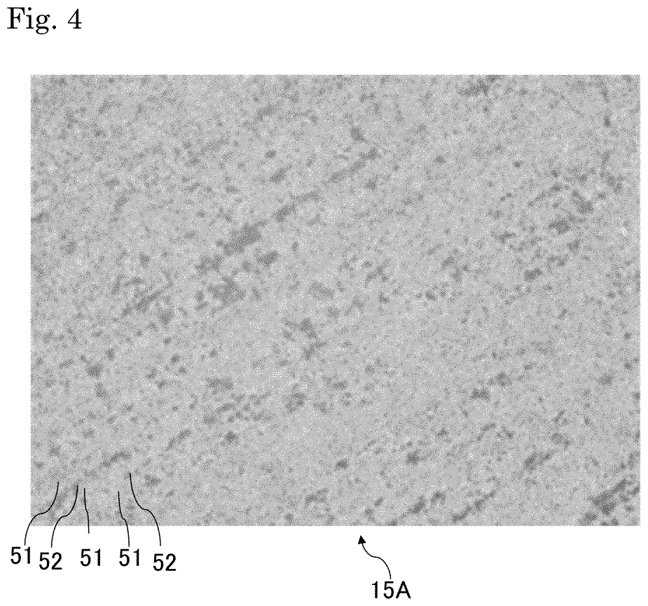

FIG. 4 is an enlarged image obtained by observing a front surface 15A of a metal sheet 15 according to a third embodiment of the present invention. In the third embodiment, again a large number of groove-like depressed portions 51 extending along each other are formed on the front surface 15A of the metal sheet 15. A streaky projecting portion 52 is formed between each pair of depressed portions 51, thereby making the front surface 15A an uneven surface.

In the third embodiment, the projecting portion 52 between each pair of depressed portions 51 is further roughened, forming projections. That is, each streaky projecting portion 52 is an elongated linear projecting portion 52 provided with further roughened projections on its top face, thereby becoming intermittent. Each of the projections does not need to be linear, and it is sufficient if the projections, when linked together, form a linear shape. On the front surface 15A, the projections made up of part other than the depressed portions 51 serve as a contact part configured to come into contact with the fixed contact points 22. The projections can be formed by being roughened by forming a roughening plating layer and the like described later, on a base plating layer formed on the projecting portion 52 between each pair of depressed portions 51, which have been formed into continuous linear grooves. Alternatively, the projections can be formed by forming the base plating layer itself into a roughened surface.

On the front surface of the metal sheet according to the third embodiment, as with the first embodiment, it is presumed that rubber-derived components enter the depressed portions 51, reducing rubber-derived components staying on the projections (contact part). Also, it is presumed that since the projections exist intermittently on each projecting portion 52, those parts of the projecting portion 52 which are exposed without projections serve as grooves partially connecting the adjacent depressed portions 51, and consequently certain convection occurs on the front surface 15A of the metal sheet 15, thereby making the rubber-derived components in a liquid state or in a state of liquid droplets less liable to stay on the front surface 15A and thereby preventing an increase in the surface resistance value.

Also, it is presumed that since the adjacent groove-like depressed portions 51 are partially connected, convection occurs in vertical and lateral directions on the front surface 15A of the metal sheet 15, making the rubber-derived components still less liable to stay on the projections on the front surface 15A and thereby making the surface resistance value still less liable to increase.

### (Surface Properties of Metal Sheet)

Preferably the front surface 15A of the metal sheet 15 has surface properties indicated in (1) to (3) below by forming the groove-like depressed portions 31, 41, or 51 and streaky projecting portions 32, 43, or 52 as with the first to third embodiments described above.

(1) The arithmetic mean height (Sa) is 0.1 to 0.5 μm
(2) The arithmetic mean peak curvature (Spc) is 960 to 20000 (l/mm), and
(3) The developed interfacial area ratio (Sdr) is 0.02 to 3.0

Here, the arithmetic mean height (Sa) is an index indicating the degree of roughness of the front surface 15A. The arithmetic mean peak curvature (Spc) is an index indicating the shape of projecting portions, and the larger the value of the index, the more acute the projecting portions. The developed interfacial area ratio (Sdr) is an index indicating how much a developed area, which is the area of a developed depression and projection, has increased from the original surface 15A assumed to be a flat surface.

If the front surface 15A of the metal sheet has the surface properties (1) and (3) above, this means that the front surface 15A has a certain quantity of groove-like depressed portions with appropriate roughness, and an increase in the surface resistance value is prevented effectively by the groove-like depressed portions. Also, if the front surface 15A has the surface property (2) above, this means that the projecting portions among the depressed portions are pointed to some extent. This makes the rubber-derived components less liable to deposit on the projecting portions and thereby makes the surface resistance value less liable to increase.

To prevent an increase in the surface resistance value of the front surface 15A more effectively, more preferably the arithmetic mean height (Sa) is 0.10 to 0.45 μm, and still more preferably 0.20 to 0.35 μm.

To prevent an increase in the surface resistance value of the front surface 15A more effectively, more preferably the developed interfacial area ratio (Sdr) is 0.10 or more, and still more preferably 0.20 or more. On the other hand, from the viewpoint of strength and durability of the projecting portions, more preferably the developed interfacial area ratio (Sdr) is 2.0 or less, and still more preferably 1.0 or less.

More preferably the arithmetic mean peak curvature (Spc) is 3000 or more, and still more preferably 4000 or more. When the arithmetic mean peak curvature (Spc) is increased, the projecting portions increase in acuteness. This makes the rubber-derived components less liable to deposit and stay on the projecting portions (contact part), and thereby prevents an increase in the surface resistance value on the front surface of the metal sheet more effectively. On the other hand, from the viewpoint of strength and durability of the projecting portions, more preferably the arithmetic mean peak curvature (Spc) is 20000 or less, and still more preferably 10000 or less.

Note that to increase the arithmetic mean height (Sa), developed interfacial area ratio (Sdr), and arithmetic mean peak curvature (Spc), it is advisable to make the streaky projecting portions intermittent as with the second and third embodiments.

According to the present invention, by being located on the front surface of the metal sheet, plural groove-like depressed portions and streaky projecting portions extending along each other have certain anisotropy. Indices that indicate the anisotropy of depressions and projections include an aspect ratio (Str). The value of the aspect ratio (Str) approaches to 0 with increase in anisotropy, and approaches to 1 with decreases in anisotropy.

Therefore, preferably the aspect ratio (Str) of the front surface of the metal sheet is 0.01 to 0.80 to cause certain anisotropy to manifest, and more preferably 0.01 to 0.30 to further increase the anisotropy. Also, from the viewpoint of more effectively curbing an increase in the surface resistance value, preferably the streaky projecting portions are intermittent, but the anisotropy decreases when the streaky projecting portions are made intermittent. Therefore, more preferably the aspect ratio (Str) of the front surface 15A of the metal sheet is 0.10 or more.

Note that the arithmetic mean height (Sa), arithmetic mean peak curvature (Spc), developed interfacial area ratio (Sdr), and aspect ratio (Str) can be measured in conformity with the surface properties (surface roughness measurements) of ISO 25178.

Also, preferably the Vickers hardness (HV) of the front surface 15A of the metal sheet according to the present invention is 100 to 550, and more preferably 120 to 400. Keeping the Vickers hardness (HV) in these ranges improves mechanical strength of the depressions and projections formed on the front surface 15A of the metal sheet and thereby improves durability and the like while improving machinability of the metal sheet.

Note that although configurations in which the rubber layer 16 is laminated to the rear surface 15B of the metal sheet 15 have been described in the above embodiments, the rubber layer may be omitted. When the rubber layer is omitted, the rear surface 15B of the metal sheet 15 is joined directly to the rubber switch body 11. Alternatively, a bonding layer made up of an adhesive or the like may be provided instead of the rubber layer.

Also, although modes in which groove-like depressed portions and streaky projecting portions are formed only on the front surface 15A of the metal sheet 15 have been described, groove-like depressed portions and streaky projecting portions may be formed on the rear surface 15B of the metal sheet 15 as well. Groove-like depressed portions and streaky projecting portions, if formed on the rear surface 15B, improve adhesiveness of the rear surface 15B of the metal sheet 15 to the rubber layer 16 and rubber switch body 11. Details of the groove-like depressed portions and streaky projecting portions formed on the rear surface 15B are similar to details of the groove-like depressed portions and streaky projecting portions formed on the front surface 15A of the metal sheet 15, and thus description thereof will be omitted.

### (Production Method for Contact Member)

Next, a production method for the contact member according to the present invention will be described in detail.

### (First Step)

The production method for the contact member according to an embodiment of the present invention includes a first step of forming a large number of groove-like depressed portions extending along each other to one another on the front surface of a metal sheet. The depressed portions can be formed by rolling, abrasion, or the like.

Specifically, the metal sheet making up the metal contact member is generally rolled into a tabular shape by a roller, and groove-like depressed portions can be formed in the rolling direction by using a roughened surface for the roller during rolling and transferring projecting portions of the roller. Also, in rolling the metal sheet, for example, hot rolling, cold rolling, and foil rolling can be performed in this order, and the groove-like depressed portions can be formed by roughening the surface of the roller used for foil rolling.

Also when abrasion is performed, it is advisable that the front surface of a metal sheet formed into a tabular shape in advance is abraded in a single direction to form groove-like depressed portions. The abrasion can be performed using abrasive grains, a grinding wheel, abrasive cloth, a wire brush, an abrasive belt, an abrasive wheel, a buff, or the like. An abrasive compounds may be used at the same time during abrasion. Also, the abrasion may be either wet abrasion or dry abrasion. Regarding abrasion conditions of the metal sheet, to form depressed portions having the surface properties described above, preferably abrasion is performed in a single direction using a buff roll or the like.

By the rolling or abrasion described above, a large number of continuous groove-like depressed portions are formed on the front surface of the metal sheet as shown in the first embodiment.

Note that as the metal sheet for use in the first step, a metal sheet equal in thickness to the metal sheet in the metal contact member can be prepared. Also, it is advisable that the metal sheet is machined into the same shape as the contact member by being cut as described later. Therefore, the metal sheet used in the first step can be sufficiently larger in area than the metal sheet in the metal contact member.

### (Second Step)

Preferably the present production method further includes a second step of processing appropriately continuous streaky projecting portions that has been formed by the rolling, abrasion, or the like to form intermittent streaky projecting portions. By forming intermittent streaky projecting portions, it is possible to make the front surface of the metal sheet similar in geometry to those of the second and third embodiments.

Methods for forming intermittent streaky projecting portions from the streaky projecting portions obtained in the first step include a method that partially divides each streaky projecting portion into segments. As a method for partially dividing the streaky projecting portions into segments, it is advisable to roughen the front surface of the metal sheet by etching. When etching is performed for roughening, as shown in the second embodiment, the streaky projecting portions are divided into segments by being partially etched away. Also, as a result of roughening, all the arithmetic mean height (Sa), arithmetic mean peak curvature (Spc), and developed interfacial area ratio (Sdr) on the front surface of the metal sheet become larger after the etching than before the etching. Surface roughening by means of etching is preferable in that it becomes easy to keep the Sa, Spc, and Sdr within desired ranges while maintaining the strength of depressions and projections.

An etching process is performed by placing, for example, an etching solution in contact with the metal sheet for a predetermined period of time. Methods for placing an etching solution in contact with the metal sheet include a method that involves immersing the metal sheet in the etching solution and a method that involves applying or spraying the etching solution to the metal sheet and then leaving the metal sheet for a predetermined period of time. Also, it is advisable to change the etching solution as appropriate according to the type of metal making up the metal sheet, and either an acid etching solution or alkaline etching solution may be used.

However, it is preferable that the metal making up the metal sheet is copper, or an alloy, such as nickel silver, containing copper as described above, and when the metal is copper or an alloy containing copper, preferably an acid etching solution is used. As the acid etching solution, an acid aqueous solution of sulfuric acid, nitric acid, hydrofluoric acid, hydrochloric acid, or the like, or an iron chloride solution is preferable.

Another method for forming intermittent streaky projecting portions from the streaky projecting portions obtained in the first step is a method that roughens the projecting portions, thereby further forming projections. Examples include a method that forms a plating layer by performing a plating process on the front surface of the metal sheet. In the present production method, the plating process is a roughening plating process and the plating layer formed on the front surface of the metal sheet is a roughening plating layer. When the roughening plating layer is formed as base plating on the streaky projecting portions, or when the roughening plating layer is formed on the base plating layer, the streaky projecting portions partially include additional projections as shown in the third embodiment. With the formation of the roughening plating layer, all the arithmetic mean height (Sa), arithmetic mean peak curvature (Spc), and developed interfacial area ratio (Sdr) on the front surface of the metal sheet become larger than before the formation of the plating layer.

The metal making up the roughening plating layer is not specifically limited, and examples of such metal include nickel, chrome, tin, copper, gold, silver, zinc, and alloys containing any of these metals, of which nickel is preferable. Also, preferably electrolytic plating is used in the plating process. The plating solution is not specifically limited, and when the plating layer is formed of nickel, a plating solution containing nickel sulfate, nickel chloride, nickel sulfamate, or the like can be used suitably.

### (Formation of Protective Plating Layer)

The protective plating layer may be formed on the front surface of the metal sheet. It is advisable that the protective plating layer is formed, on the front surface of the metal sheet, for example, after continuous or intermittent streaky projecting portions are formed as described above. That is, when the second step is performed after the first step, it is advisable that the protective plating layer is formed after the second step. When the second step is not performed, it is advisable that the protective plating layer is formed after the first step.

Preferably the protective plating layer is a gold plating layer formed of gold or an alloy containing gold as described above. The gold plating layer, when formed, increases the electrical conductivity of the metal sheet and improves durability.

### (Formation of Rubber Layer)

Also, in the present production method, it is advisable that a rubber layer is laminated to a reverse side of the metal sheet. It is advisable that the rubber layer is formed by stacking a rubber sheet on the rear surface of the metal sheet and carrying out contact bonding thereof. Before the contact bonding of the rubber sheet, a primer may be applied to the rear surface of the metal sheet. It is advisable that the rubber layer is formed on the rear surface of the metal sheet after continuous or intermittent streaky projecting portions are formed. That is, when the second step is performed after the first step, it is advisable that the rubber layer is formed after the second step. When the second step is not performed, it is advisable that the rubber layer is formed after the first step. Also, when a protective plating layer is formed, it is advisable that the rubber layer is formed after the protective plating layer is formed.

However, the timing of forming the rubber layer is not specifically limited, and the rubber layer may be formed before continuous or intermittent streaky projecting portions are formed or after the streaky projecting portions are formed but before the protective plating layer is formed.

A laminated body of the rubber layer and metal sheet is cut into a predetermined shape, thereby providing a metal contact member of a predetermined shape. The cutting of the laminated body is not specifically limited, but is advisably done by stamping or the like.

### (Production Method for Rubber Switch Member)

The rubber switch member according to the present invention can be produced by integrating the metal contact member obtained as described above and the rubber making up the rubber switch body. The method for that is not specifically limited, and insert molding is preferable. The mold used for insert molding has a cavity of a shape corresponding to the rubber switch member. The insert molding involves placing the metal contact member in the cavity, pouring or putting rubber, heating the mold, and thereby curing, vulcanizing, and cross-linking the rubber to obtain the rubber switch member. The heating temperature of the mold is not specifically limited, and is, for example, about 100 to 200° C.

In the production of the rubber switch member, to cure, vulcanize, and cross-link the rubber, the mold is heated as described above. Part of the rubber-derived components gasified or liquefied by the heating attach to the front surface of the metal sheet, which might increase the surface resistance value of the metal sheet, but according to the present invention, since large numbers of groove-like depressed portions and streaky projecting portions are formed on the front surface of the metal sheet, an increase in the surface resistance value is curbed.

Note that whereas metal contact members each provided with a rubber layer have been described in the above description of production methods, the rubber layer may be omitted as described above, and instead of the rubber layer, an adhesive layer or the like may be laminated to the rear surface of the metal sheet.

### EXAMPLES

The present invention will be described in more detail using examples, but the present invention is in no way limited by these examples.

Note that in the examples, the methods for measuring physical properties were as follows.

### [Arithmetic Mean Height (Sa), Arithmetic Mean Peak Curvature (Spc), Developed Interfacial Area Ratio (Sdr), and Aspect Ratio (Str)]

The arithmetic mean height (Sa), arithmetic mean peak curvature (Spc), developed interfacial area ratio (Sdr), and aspect ratio (Str) were measured in conformity with ISO 25178 by observing the front surfaces of metal sheets under a laser microscope (LASER MICROSCOPE VK-X150 produced by Keyence Corporation) at a lens magnification of 50 (on-screen magnification of 1200).

### [Vickers Hardness]

The Vickers hardness on the front surfaces of metal sheets was measured in conformity with JIS Z 2244:2009.

### [Surface Resistance Value]

Regarding the surface resistance value, a comb-shaped electrode substrate on pitch of 0.6 mm with a wire-electrode width of 300 μm and a space of 300 μm between adjacent wire electrodes was prepared and a resistance value between wire electrodes was measured by pressing a metal sheet (metal contact member 3 mm in diameter) against the electrode substrate under a load of 9.8 N at a velocity of 10 mm/min.

### [Adhesion to Rubber Layer]

Laminated bodies were made by respective methods of examples and a comparative example except that the thicknesses of both rubber layer and metal sheets were changed to 1.5 mm, the laminated bodies were cut into the shape of test pieces, and adhesion between the rubber layer and metal sheet was measured in terms of peel strength using the 90-degree peel method of JIS K 6256-2:2013 and evaluated based on the following evaluation criteria.

A: The peel strength was 80 N (per 25-mm width) or more, indicating that adhesion between the rubber layer and metal sheet was extremely good.

B: The peel strength was 30 N (per 25-mm width) or more and less than 80 N, indicating that adhesion between the rubber layer and metal sheet was good.

### Example 1

Plural groove-like depressed portions and streaky projecting portions extending along each other were formed on both surfaces of a 70-μm thick metal sheet of nickel silver by abrading the surfaces in a single direction using a buff roll.

Subsequently, a gold plating layer was formed on one surface of the metal sheet. A primer was applied to the surface of the metal sheet opposite the surface on which the gold plating layer was formed, a 500-μm thick silicone rubber sheet was superimposed on the primer, the metal sheet was press heated, and thereby a laminated body of the metal sheet and rubber layer was obtained. The laminated body was stamped to obtain a 3-mm diameter metal contact member.

The metal contact member obtained was put in a mold for insert molding, and silicone rubber was poured into the mold. Subsequently, the mold was heated at 170° C. for 5 minutes, thereby cross-linking the silicone rubber, the metal contact member and rubber switch body were integrated, and consequently the rubber switch member shown in FIG. 1 was obtained.

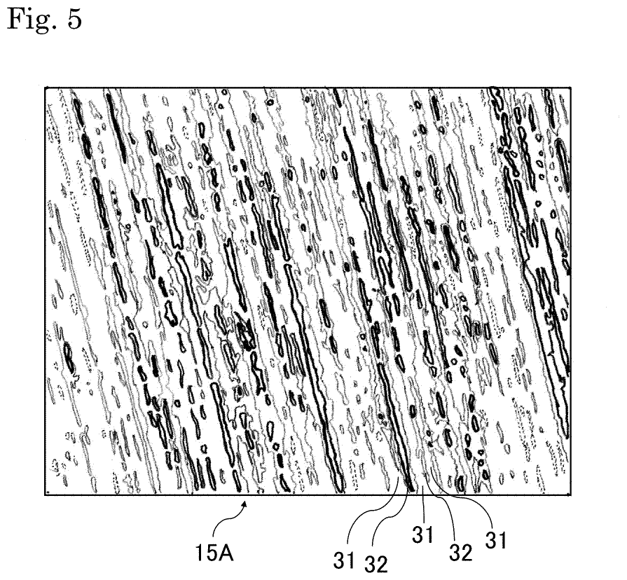

Note that the front surface of the metal sheet obtained in Example 1 was observed under a laser microscope (LASER MICROSCOPE VK-X150 produced by Keyence Corporation) at a lens magnification of 50 (on-screen magnification of 1200) and an image analysis process was performed such that colors will differ along the height direction. The larger the height, the denser the red color while the lower the height, the denser the blue color, but FIG. 2 is shown in black and white. Also, a diagram obtained by tracing the image shown in FIG. 2 by likening color gradation to contour lines is shown in FIG. 5. In FIG. 5, thick lines, thin lines, and dotted lines represent contour lines in descending order of height.

### Example 2

Groove-like depressed portions were formed on both surfaces by abrading the metal sheet as with Example 1, then an etching process was performed by immersing the metal sheet in an acid etching solution (iron chloride solution), the streaky projecting portions were divided into segments by roughening both surfaces of the metal sheet, and consequently intermittent streaky projecting portions were formed on both surfaces of the metal sheet. Then, a gold plating layer was formed on one surface of the metal sheet as with Example 1, subsequently, operation similar to Example 1 was performed, and consequently a metal contact member and rubber switch member were obtained.

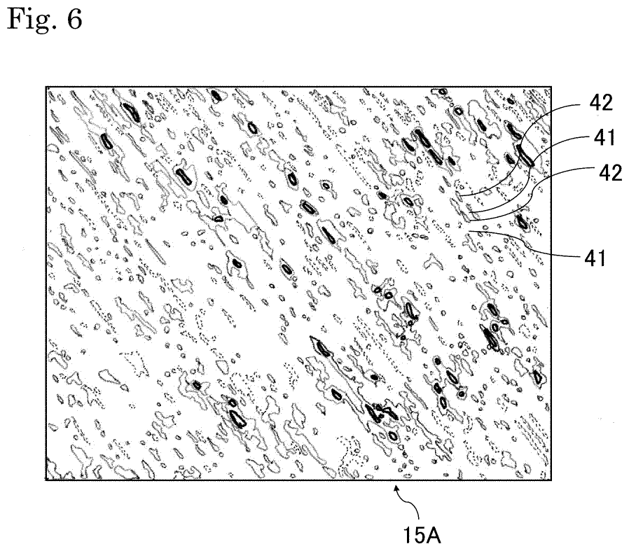

Note that an image obtained by observing the front surface of the metal sheet obtained in Example 2 under conditions similar to Example 1 is shown in FIG. 3. Also, an image obtained by tracing the image shown in FIG. 3 in a manner similar to FIG. 5 is shown in FIG. 6.

### Example 3

Groove-like depressed portions were formed on both surfaces by abrading the metal sheet as with Example 1, then an electrolytic plating process was performed by immersing the metal sheet in a nickel chloride plating solution, forming a roughening nickel plating layer on both surfaces of the metal sheet, the projecting portions were roughened, thereby further forming projections, and consequently intermittent streaky projecting portions were formed. Then, a gold plating layer was formed on one surface of the metal sheet as with Example 1, subsequently, operation similar to Example 1 was performed, and consequently a metal contact member and rubber switch member were obtained.

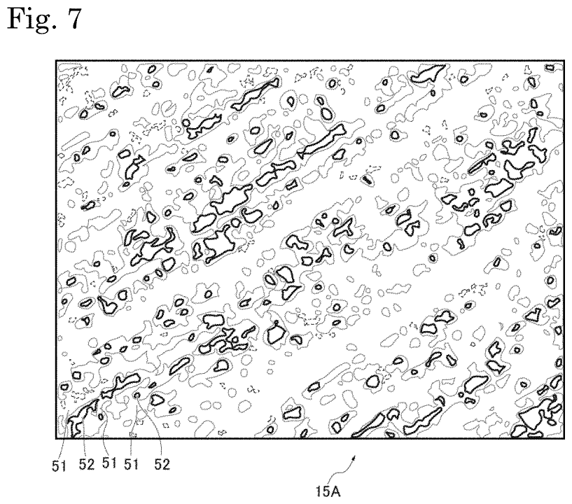

Note that an image obtained by observing the front surface of the metal sheet obtained in Example 3 under conditions similar to Example 1 is shown in FIG. 4. Also, an image obtained by tracing the image shown in FIG. 4 in a manner similar to FIG. 5 is shown in FIG. 7.

### Comparative Example 1

Both surfaces of a 70-μm thick metal sheet of nickel silver were abraded in multiple directions. Then, a gold plating layer was formed on one surface of the metal sheet as with Example 1, subsequently, operation similar to Example 1 was performed, and consequently a metal contact member and rubber switch member were obtained. The surfaces of the metal sheet making up the metal contact member had a geometry close to that of a smooth surface, with minute groove-like depressed portions being formed in multiple directions.

TABLE 1

| | | | | Comparative |
|---|---|---|---|---|
| | Example 1 | Example 2 | Example 3 | example 1 |
| Sa (μm) | 0.11 | 0.27 | 0.43 | 0.03 |
| Str | 0.04 | 0.21 | 0.62 | 0.32 |
| Spc (1/mm) | 1116 | 7725 | 17672 | 576 |
| Sdr | 0.04 | 0.54 | 2.85 | 0.01 |
| Surface resistance | 0.12 | 0.07 | 0.04 | 0.39 |
| value (Ω) | | | | |
| Vickers hardness | 400 | 400 | 400 | 400 |
| (HV) | | | | |
| Adhesion to | A | A | A | B |
| rubber layer | | | | |

Thus, by forming groove-like depressed portions extending along each other on the surfaces of the metal sheet, Examples 1 to 3 were able to curb an increase in surface resistance value attributable to rubber-derived components separated during formation of the rubber switch member.

### REFERENCE SIGNS LIST

10 Metal contact member
11 Rubber switch body
11A Pusher
11B Flexible portion
11C Base
12 Rubber switch member
15 Metal sheet
15A Front surface
15B Rear surface
16 Rubber layer
21 Substrate
22 Fixed contact point
25 Switch
31, 41, 51 Depressed portion
32, 42, 52 Projecting portion

1. A metal contact member comprising a metal sheet, the metal sheet having a plurality of streaky projecting portions extending along each other on a surface thereof.

2. The metal contact member according to claim 1, wherein the streaky projecting portions are formed intermittently.

3. The metal contact member according to claim 1, wherein the surface of the metal sheet is 0.1 to 0.5 μm in arithmetic mean height (Sa), 960 to 20000 (l/mm) in arithmetic mean peak curvature (Spc), and 0.02 to 3.0 in developed interfacial area ratio (Sdr).

4. The metal contact member according to claim 1, further comprising a rubber layer laminated to a rear surface of the metal sheet.

5. The metal contact member according to claim 4, wherein the rubber layer contains silicone rubber.

6. A rubber switch member comprising the metal contact member according to claim 1; and a rubber switch body joined to the metal contact member.

7. The rubber switch member according claim 6, wherein the rubber switch body contains silicone rubber.
